(19) United States
(12) Patent Application Publication
(10) Pub. No.: US 2025/0034735 A1
(43) Pub. Date: Jan. 30, 2025

(54) HYDROGEN PRODUCTION SYSTEM

(71) Applicant: DENSO CORPORATION, Kariya-city (JP)

(72) Inventors: Toshihisa NAKAJIMA, Kariya-city (JP); Kota SHIBATA, Kariya-city (JP); Yasutoshi DOI, Kariya-city (JP); Shota CHATANI, Kariya-city (JP); Daichi SAKURAI, Kariya-city (JP); Shinji KAWADA, Kariya-city (JP); Hideaki OKAWA, Kariya-city (JP); Seiichiro WASHINO, Kariya-city (JP); Takashi KANEKO, Kariya-city (JP)

(21) Appl. No.: 18/914,958

(22) Filed: Oct. 14, 2024

Related U.S. Application Data
(63) Continuation of application No. PCT/JP2023/006263, filed on Feb. 21, 2023.

(30) Foreign Application Priority Data
Apr. 21, 2022 (JP) 2022-069988

(51) Int. Cl. C25B 15/02; B01D 53/02; B01D 53/26

(52) U.S. Cl. CPC C25B 15/02; B01D 53/02; B01D 53/261; B01D 2257/80

(57) ABSTRACT

A hydrogen production system includes a hydrogen generation device to generate hydrogen, and a compressor to compress the hydrogen. The hydrogen generation device and the compressor are connected by a first line. The compressor and a hydrogen utilization equipment to utilize the hydrogen compressed by the compressor are connected by a second line. A hydrogen storage unit to store the hydrogen compressed by the compressor is connected to the first line by a first bypass line. The first bypass line has a first control valve to control a flow of the hydrogen in the first bypass line.

### CROSS REFERENCE TO RELATED APPLICATION

The present application is a continuation application of International Patent Application No. PCT/JP2023/006263 filed on Feb. 21, 2023, which designated the U.S. and claims the benefit of priority from Japanese Patent Application No. 2022-069988 filed on Apr. 21, 2022. The entire disclosures of all of the above applications are incorporated herein by reference.

### TECHNICAL FIELD

The present disclosure relates to a hydrogen production system.

### BACKGROUND

A hydrogen production apparatus to produce hydrogen includes a water vapor generation device, an electrolysis cell, a cooler, a gas-liquid separator, a hydrogen compressor, and a hydrogen storage unit.

### SUMMARY

According to an aspect of the present disclosure, a hydrogen production system includes: a hydrogen generation device to generate hydrogen; a compressor to compress the hydrogen; a first line connecting the hydrogen generation device to the compressor; a second line connecting the compressor to a hydrogen utilization equipment to utilize the hydrogen compressed by the compressor; a hydrogen storage unit to store the hydrogen compressed by the compressor; a first bypass line connecting the hydrogen storage unit to the first line; and a first control valve provided in the first bypass line to control a flow of the hydrogen in the first bypass line.

### BRIEF DESCRIPTION OF DRAWINGS

The above and other objects, features and advantages of the present disclosure will become more apparent from the following detailed description made with reference to the accompanying drawings. In the drawings,

FIG. 1 is a block diagram showing a hydrogen production system according to a first embodiment in which all valves are closed;

FIG. 2 is a block diagram in which a hydrogen generation device is started and a first control valve and a main control valve are open in the hydrogen production system of the first embodiment;

FIG. 3 is a block diagram in which the hydrogen generation device is started and a supply valve and the main control valve are open in the hydrogen production system of the first embodiment;

FIG. 4 is a block diagram in which the hydrogen generation device is started and the main control valve is open in the hydrogen production system of the first embodiment;

FIG. 5 is a block diagram in which the hydrogen generation device is started and the main control valve and a relief valve are open in the hydrogen production system of the first embodiment;

FIG. 6 is a block diagram in which the hydrogen generation device is stopped and the first control valve and the main control valve are open in the hydrogen production system of the first embodiment;

FIG. 7 is a block diagram in which the hydrogen generation device is stopped and the supply valve and the main control valve are open in the hydrogen production system of the first embodiment;

FIG. 8 is a flowchart showing a main routine related to the overall operation of the hydrogen production system of the first embodiment;

FIG. 9 is a flowchart showing an ON process of the hydrogen production system according to the first embodiment;

FIG. 10 is a flowchart showing an OFF process of the hydrogen production system according to the first embodiment;

FIG. 11 is a block diagram showing a hydrogen production system according to a second embodiment;

FIG. 12 is a block diagram showing a hydrogen production system according to a third embodiment;

FIG. 13 is a block diagram showing a hydrogen production system according to a fourth embodiment;

FIG. 14 is a block diagram showing a hydrogen production system according to a fifth embodiment;

FIG. 15 is a block diagram in which all valves are closed in a hydrogen production system according to a sixth embodiment;

FIG. 16 is a block diagram in which a hydrogen generation device is started and a first control valve and a main control valve are open in the hydrogen production system of the sixth embodiment;

FIG. 17 is a block diagram in which the hydrogen generation device is started and a second control valve and the main control valve are open in the hydrogen production system of the sixth embodiment;

FIG. 18 is a block diagram in which the hydrogen generation device is stopped and the first control valve and the main control valve are open in the hydrogen production system of the sixth embodiment;

FIG. 19 is a flowchart showing an ON process of the hydrogen production system according to the sixth embodiment;

FIG. 20 is a flowchart showing an OFF process of the hydrogen production system according to the sixth embodiment;

FIG. 21 is a view showing a determination condition for starting/stopping the hydrogen generation device in the first embodiment;

FIG. 22 is a view showing a determination condition for opening/closing the first control valve and the supply valve in the first embodiment; and

FIG. 23 is a view showing a determination condition for opening/closing the first control valve and the second control valve in the sixth embodiment.

### DETAILED DESCRIPTION

A hydrogen production apparatus produces hydrogen. The hydrogen production apparatus includes: a water vapor generation device that heats water to generate water vapor; an electrolysis cell to generate hydrogen and oxygen through high-temperature steam electrolysis; a cooler that cools water vapor that did not react in the high-temperature steam electrolysis to condense the water vapor into water; a gas-liquid separator that separates the hydrogen and the water from each other; a hydrogen compressor that compresses the hydrogen and transfers the thermal energy generated when compressing the hydrogen to the water; and a hydrogen storage unit that stores the compressed hydrogen.

The hydrogen stored in the hydrogen storage unit is supplied to a hydrogen utilization equipment that utilizes hydrogen. However, for example, if the pressure of the hydrogen stored in the hydrogen storage unit falls below a hydrogen pressure required by the hydrogen utilization equipment, there is a concern that hydrogen will not be able to be supplied from the hydrogen storage unit to the hydrogen utilization equipment. For this reason, it would may not possible to use up all the hydrogen remaining in the hydrogen storage unit.

The present disclosure provides a hydrogen production system to use up hydrogen stored in a hydrogen storage unit.

According to an aspect of the present disclosure, a hydrogen production system is provided with: a hydrogen generation device to generate hydrogen; a compressor to compress the hydrogen; a first line connecting the hydrogen generation device and the compressor; a second line connecting the compressor and a hydrogen utilization equipment to utilize the hydrogen pressurized by the compressor; a hydrogen storage unit that stores the hydrogen pressurized by the compressor; a first bypass line connecting the hydrogen storage unit to the first line; and a first control valve provided in the first bypass line to control a flow of the hydrogen in the first bypass line.

By opening the first control valve, the hydrogen stored in the hydrogen storage unit can be circulated to the first line via the first bypass line. The hydrogen circulated through the first line is compressed by the compressor, and supplied to the hydrogen utilization equipment through the second line. This makes it possible to use up the hydrogen stored in the hydrogen storage unit even when it is difficult to supply hydrogen from the hydrogen storage unit to the second line, for example, when the pressure of the hydrogen stored in the hydrogen storage unit falls below the pressure of the hydrogen circulating through the second line.

According to the above aspect, it is possible to provide a hydrogen production system to finish using the hydrogen stored in the hydrogen storage unit.

### First Embodiment

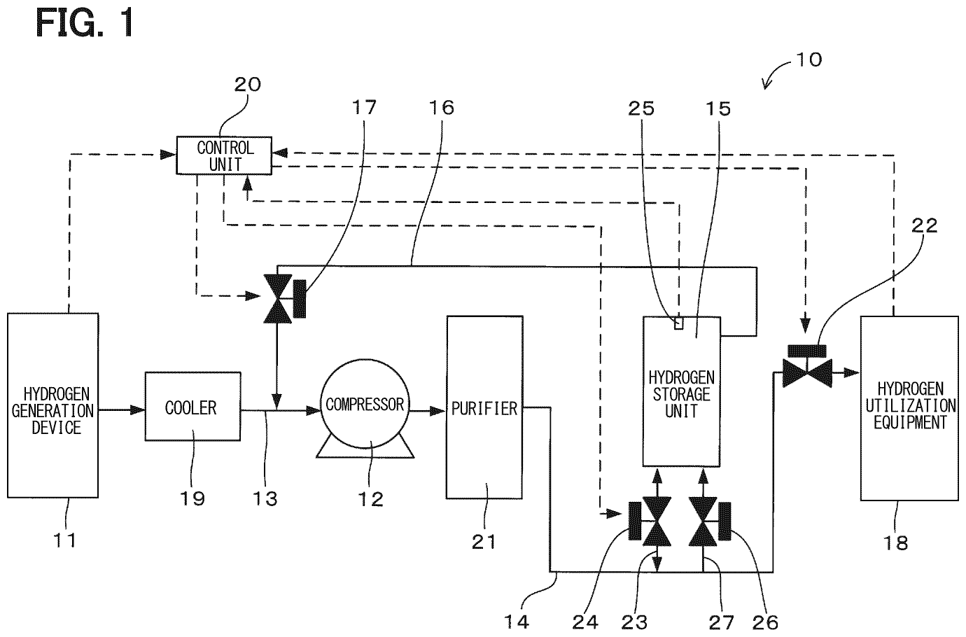

A hydrogen production system 10 according to a first embodiment will be described with reference to FIGS. 1 to 10. As shown in FIG. 1, the hydrogen production system 10 of this embodiment includes a hydrogen generation device 11, a compressor 12, a first line 13, a second line 14, a hydrogen storage unit 15, a first bypass line 16, and a first control valve 17. The hydrogen generation device 11 generates hydrogen. The compressor 12 compresses the hydrogen generated by the hydrogen generation device 11. The hydrogen generation device 11 and the compressor 12 are connected by the first line 13. The compressor 12 and a hydrogen utilization equipment 18 that utilizes the hydrogen compressed by the compressor 12 are connected by the second line 14. The hydrogen pressurized by the compressor 12 is stored in the hydrogen storage unit 15. The hydrogen storage unit 15 and the first line 13 are connected by the first bypass line 16. The first control valve 17 is provided in the first bypass line 16. The first control valve 17 controls the flow of hydrogen in the first bypass line 16.

Next, an overview of the hydrogen production system 10 will be described with reference to FIG. 1. The hydrogen generation device 11 in this embodiment is not particularly limited while it is a device that generates hydrogen. Although not shown in detail, the hydrogen generation device 11 of this embodiment is an electrolysis cell that generates hydrogen and oxygen by electrolyzing water. The hydrogen generation device 11 includes a cathode (not shown), an anode (not shown), and an electrolyte (not shown) disposed between the cathode and the anode. The electrolyte is not particularly limited, and can be appropriately selected, for example, from a solid oxide electrolyte, a proton-conducting ceramic electrolytic cell, a proton exchange membrane, an alkaline water electrolyte, and the like. In this embodiment, a solid oxide electrolyte is used.

The first line 13 is connected to the hydrogen generation device 11. As a result, the hydrogen generated by the hydrogen generation device 11 flows through the first line 13. The first line 13 includes a pipe.

A cooler 19 is disposed in the first line 13. The hydrogen flowing through the first line 13 is supplied to the cooler 19 and cooled. As a result, the unreacted water contained in the hydrogen generated by the hydrogen generation device 11 is condensed. As a result, the hydrogen is dehumidified.

The hydrogen dehumidified by the cooler 19 is supplied to the compressor 12 via the first line 13. The compressor 12 compresses the hydrogen to have a predetermined pressure. The output of the compressor 12 may be constant, or may be changed by a control unit 20, which will be described later.

The second line 14 is connected to the compressor 12. The hydrogen pressurized by the compressor 12 flows through the second line 14. The second line 14 includes a pipe.

A purifier 21 is disposed in the second line 14. The hydrogen flowing through the second line 14 is supplied to the purifier 21. In the purifier 21, for example, unreacted water, impurity gases other than hydrogen, etc. are removed from the hydrogen by a method such as adsorption. This makes it possible to increase the purity of hydrogen.

The hydrogen whose purity has been increased by the purifier 21 is supplied to the hydrogen utilization equipment 18 via the second line 14. The hydrogen utilization equipment 18 is not particularly limited. The hydrogen utilization equipment 18 can produce chemical substances using hydrogen as a raw material, perform reduction processing in a reducing atmosphere formed by the hydrogen, or manufacture and process products in a reducing atmosphere formed by the hydrogen.

A supply control valve 22 is disposed in the second line 14 to control the amount of hydrogen supplied to the hydrogen utilization equipment 18. The amount of hydrogen supplied to the hydrogen utilization equipment 18 is adjusted by controlling the opening degree of the supply control valve 22.

The second line 14 has a supply line 23 arranged in a region between the purifier 21 and the supply control valve 22, to connect the second line 14 to the hydrogen storage unit 15 in which hydrogen is stored. This allows hydrogen to flow between the second line 14 and the hydrogen storage unit 15 via the supply line 23 branching off from the second line 14. The hydrogen stored in the hydrogen storage unit 15 is supplied to the hydrogen utilization equipment 18 via the second line 14. A supply valve 24 to control the amount of hydrogen flowing through the supply line 23 is disposed in the supply line 23.

The hydrogen storage unit 15 is configured to store hydrogen. The configuration of the hydrogen storage unit 15 is not particularly limited, and can be a tank having a storage space, a container containing a hydrogen storage alloy, or a container containing a compound capable of storing hydrogen. The hydrogen storage unit 15 in this embodiment is a tank. The hydrogen storage unit 15 is equipped with a storage pressure sensor 25 that detects the stored hydrogen pressure, which is the pressure of the hydrogen stored in the hydrogen storage unit 15.

A relief line 27 equipped with a relief valve 26 is provided between the second line 14 and the hydrogen storage unit 15, parallel to the supply line 23. The relief line 27 is located between the hydrogen utilization equipment 18 and the supply line 23. The relief valve 26 is configured to open when a pressure greater than a predetermined operating pressure is applied, and to allow hydrogen to flow from the second line 14 to the hydrogen storage unit 15. When the pressure applied to the relief valve 26 is lower than a predetermined operating pressure, the relief valve 26 is closed, and the flow of hydrogen between the second line 14 and the hydrogen storage unit 15 is stopped. The value of the operating pressure is not particularly limited. For example, the operating pressure in this embodiment is 0.95 MPa·G. Even if the relief valve 26 is in an open state, hydrogen is restricted from flowing from the hydrogen storage unit 15 to the second line 14.

The first bypass line 16 connects the first line 13 between the cooler 19 and the compressor 12 to the hydrogen storage unit 15. Hydrogen is able to flow through the first bypass line 16 between the hydrogen storage unit 15 and the first line 13 located between the cooler 19 and the compressor 12.

The first bypass line 16 is provided with a first control valve 17. By adjusting the opening degree of the first control valve 17, the amount of hydrogen circulating between the first line 13 and the hydrogen storage unit 15 is controlled.

Each of the first control valve 17, the supply control valve 22, the supply valve 24 and the relief valve 26 may be configured as a solenoid valve, for example.

The hydrogen production system 10 of this embodiment includes the control unit 20. The control unit 20 includes a microcomputer having a processor, memory, etc., and its peripheral circuits. The control unit 20 receives a signal, from the hydrogen generation device 11, of the hydrogen flow rate, which is a flow rate of hydrogen generated by the hydrogen generation device 11. The control unit 20 receives signals, from the hydrogen utilization equipment 18, of a required hydrogen flow rate, which is a flow rate of hydrogen required for the hydrogen utilization equipment 18 to the hydrogen generation device 11, and a required hydrogen pressure, which is a hydrogen pressure required for the hydrogen utilization equipment 18 to the hydrogen generation device 11. The control unit 20 receives a signal of the stored hydrogen pressure from a storage pressure sensor 25 of the hydrogen storage unit 15.

The control unit 20 opens or closes the first control valve 17 and the supply valve 24 based on the values of the produced hydrogen flow rate, the required hydrogen flow rate, the required hydrogen pressure, and the stored hydrogen pressure.

The control unit 20 is configured to open the first control valve 17, at least when the produced hydrogen flow rate is smaller than the required hydrogen flow rate, provided that the stored hydrogen pressure is smaller than a threshold value set in response to the required hydrogen pressure.

The threshold value is arbitrarily set based on the required hydrogen pressure. For example, when the production conditions of the hydrogen generation device 11 are changed or the opening degree of the first control valve 17 is changed, the flow rate and pressure of the hydrogen circulating within the hydrogen production system 10 change. At this time, it is conceivable that a response delay will occur while the hydrogen is supplied to the hydrogen utilization equipment 18 under the changed conditions, if the production conditions of the hydrogen generation device 11 are changed or if the opening degree of the first control valve 17 is changed. For this reason, a threshold value is set for the required hydrogen pressure, taking into consideration the above-mentioned response delay. This threshold value varies depending on the response delay of the hydrogen production system 10 and the hydrogen pressure required by the hydrogen utilization equipment 18. Therefore, the threshold value is set individually for each hydrogen production system 10. In this embodiment, the threshold value is set to the required hydrogen pressure+0.05 MPa·G. The required hydrogen pressure is set at 0.55 MPa·G. Therefore, the threshold value is set to 0.6 MPa·G. However, the required hydrogen pressure is not limited to 0.55 MPa·G. The threshold value is not limited to the required hydrogen pressure+0.05 MPa·G.

In FIG. 1, the first control valve 17, the supply valve 24, the relief valve 26 and the supply control valve 22 which are shown in black represent a closed state, and which are shown in white represent an open state. The same applies below.

Next, a hydrogen production process of the hydrogen production system 10 will be described below. The hydrogen production process is not limited to the following description.

A start-up of the hydrogen production system 10 will be described. When the hydrogen production system 10 is stopped, the first control valve 17, the supply valve 24, and the supply control valve 22 provided in the hydrogen production system 10 are in a closed state as shown in FIG. 1. When the hydrogen production system 10 is stopped, no pressure is applied to the relief valve 26, so the relief valve 26 is in a closed state.

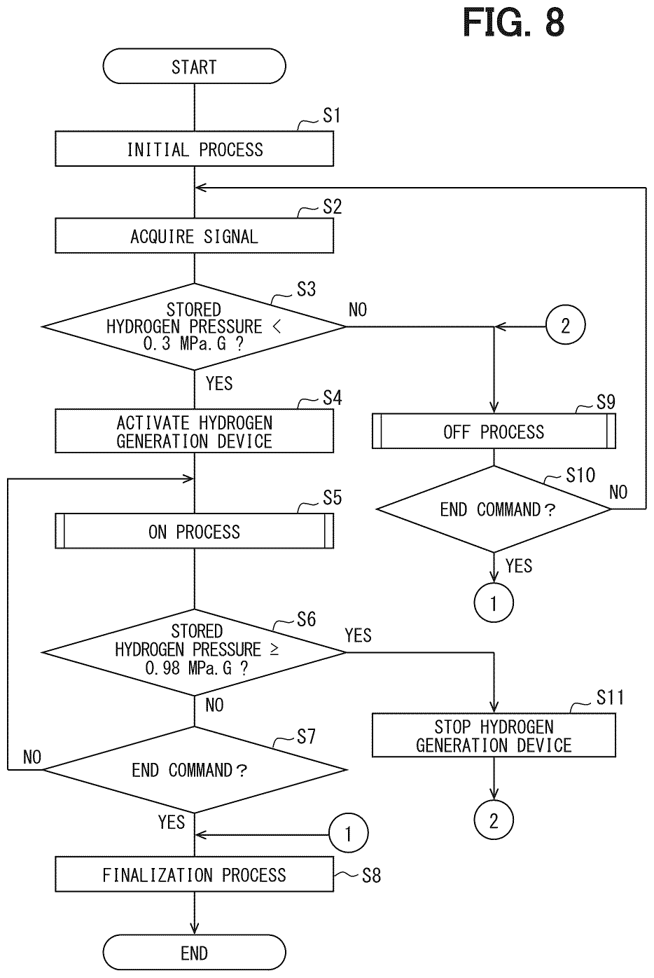

FIG. 8 shows a flow chart of a main routine of the hydrogen production process according to this embodiment. When the control unit 20 receives a command to start operation while the hydrogen production system 10 is stopped, the control unit 20 activates the hydrogen production system 10. The control unit 20 executes an initial process (S1). That is, the control unit 20 starts the cooler 19, the compressor 12, and the purifier 21, and then opens the supply control valve 22.

Next, the control unit 20 receives hydrogen pressure and flow rate signals (S2). That is, the control unit 20 receives a signal of the produced hydrogen flow rate from the hydrogen generation device 11, signals of the required hydrogen pressure and the required hydrogen flow rate from the hydrogen utilization equipment 18, and a signal of the stored hydrogen pressure from the hydrogen storage unit 15.

An ON process will be described. The control unit 20 determines whether the stored hydrogen pressure is lower than a predetermined pressure (S3). In this embodiment, the predetermined pressure is set to 0.3 MPa·G. However, the predetermined pressure is not limited to 0.3 MPa·G. When the control unit 20 determines that the stored hydrogen pressure is lower than 0.3 MPa·G (S3: Y), the control unit 20 activates the hydrogen generation device 11 (S4). As a result, hydrogen is generated by the hydrogen generation device 11. Next, the control unit 20 causes the hydrogen production system 10 to execute an ON process (S5). The ON process is executed when the hydrogen generation device 11 is in an activated state.

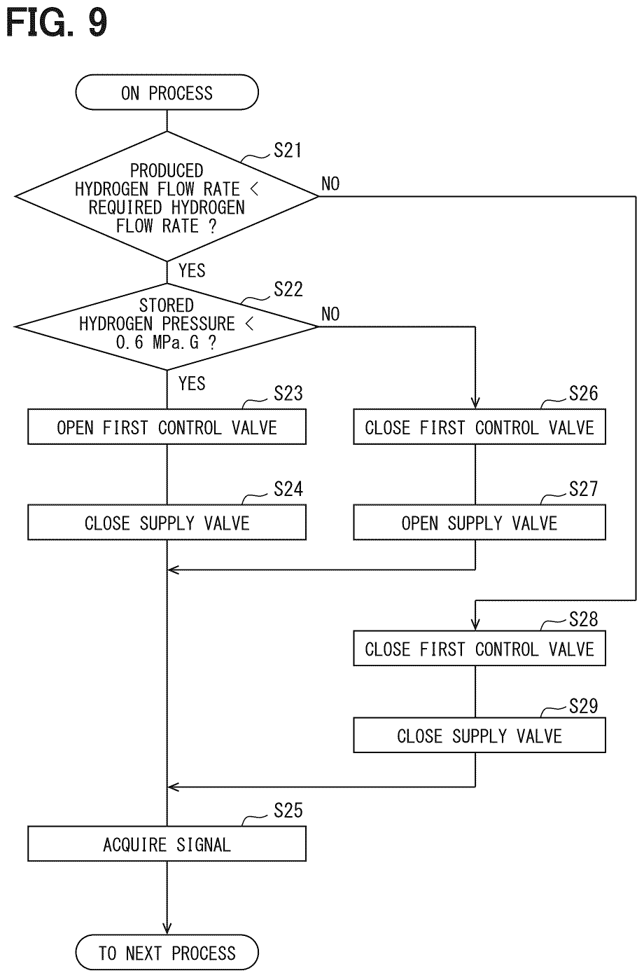

FIG. 9 shows a flowchart of the ON process. The control unit 20 determines whether the produced hydrogen flow rate is smaller than the required hydrogen flow rate (S21). When the control unit 20 determines that the produced hydrogen flow rate is smaller than the required hydrogen flow rate (S21: Y), the control unit 20 determines whether the stored hydrogen pressure is smaller than 0.6 MPa·G (S22). When the control unit 20 determines that the stored hydrogen pressure is lower than 0.6 MPa·G (S22: Y), the control unit 20 opens the first control valve 17 (S23). Furthermore, the control unit 20 closes the supply valve 24 (S24).

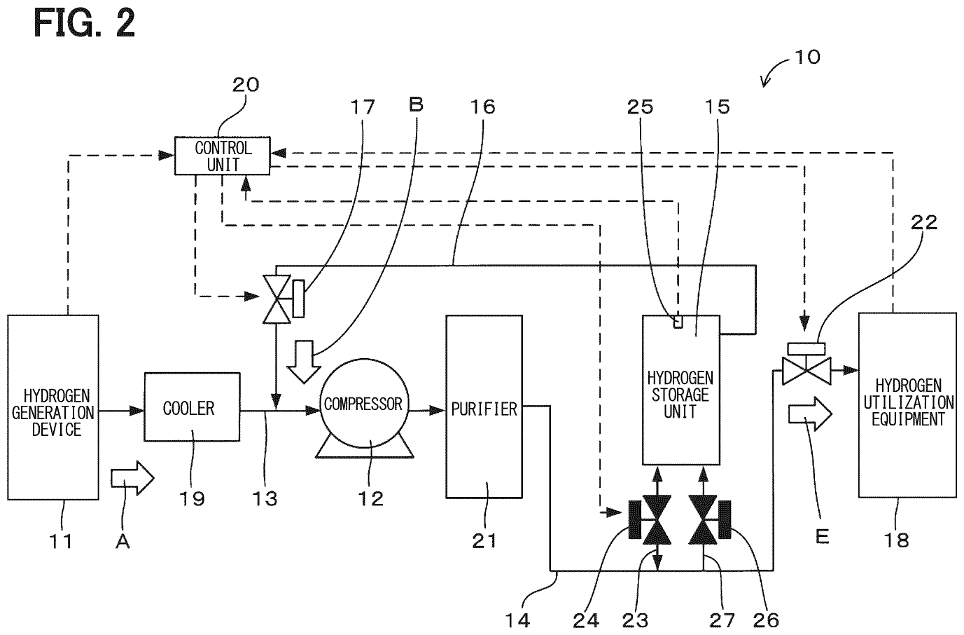

In FIG. 2, the first control valve 17 and the supply control valve 22 are shown in white. In other words, the first control valve 17 and the supply control valve 22 are in an open state. On the other hand, the supply valve 24 and the relief valve 26 shown in black means the supply valve 24 and the relief valve 26 are in a closed state. In this state, the hydrogen generated in the hydrogen generation device 11 flows through the hydrogen generation device 11, the cooler 19, the compressor 12, the purifier 21, the supply control valve 22, and the hydrogen utilization equipment 18, as shown by the arrow A. In addition, the hydrogen stored in the hydrogen storage unit 15 passes through the hydrogen storage unit 15, the first bypass line 16, and the first control valve 17, as shown by the arrow B, and flows into the first line 13 to circulate through the compressor 12, the purifier 21, the supply control valve 22, and the hydrogen utilization equipment 18. The hydrogen supplied to the hydrogen utilization equipment 18 is indicated by the arrow E. Hydrogen from the hydrogen generation device 11 indicated by the arrow A and hydrogen from the hydrogen storage unit 15 indicated by the arrow B are supplied to the hydrogen utilization equipment 18 in a joined state.

As shown in FIG. 9, when the control unit 20 determines in S22 that the stored hydrogen pressure is not lower than 0.6 MPa·G (S22: N), the control unit 20 closes the first control valve 17 (S26). Furthermore, the control unit 20 opens the supply valve 24 (S27).

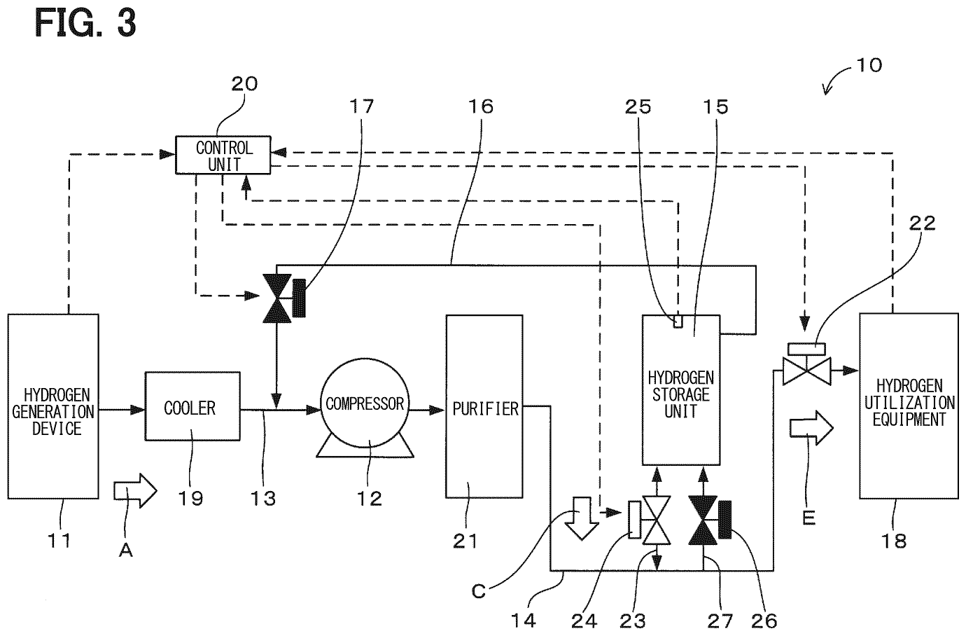

In FIG. 3, the supply valve 24 and the supply control valve 22 are shown in white. That is, the supply valve 24 and the supply control valve 22 are in an open state. On the other hand, the first control valve 17 and the relief valve 26 shown in black means that the first control valve 17 and the relief valve 26 are in a closed state. In this state, the hydrogen generated in the hydrogen generation device 11 flows through the hydrogen generation device 11, the cooler 19, the compressor 12, the purifier 21, the supply control valve 22, and the hydrogen utilization equipment 18, as shown by the arrow A. Furthermore, as indicated by the arrow C, the hydrogen stored in the hydrogen storage unit 15 passes through the supply valve 24, merges with the second line 14, and flows to the supply control valve 22 and the hydrogen utilization equipment 18. Hydrogen from the hydrogen generation device 11 indicated by the arrow A and hydrogen from the hydrogen storage unit 15 indicated by the arrow C are supplied to the hydrogen utilization equipment 18 in a joined state.

Furthermore, as shown in FIG. 9, when the control unit 20 determines in S21 that the produced hydrogen pressure is not lower than the required hydrogen pressure (S21: N), the control unit 20 closes the first control valve 17 (S28). Furthermore, the control valve closes the supply valve 24 (S29). When the control unit 20 executes S28, the control unit 20 does not determine whether the stored hydrogen pressure is less than 0.6 MPa·G. Therefore, even when the stored hydrogen pressure is less than 0.6 MPa·G, the first control valve 17 may be in a closed state.

When S28 and S29 are executed by the control unit 20, the produced hydrogen flow rate is not smaller than the required hydrogen flow rate (S21: N). In other words, the flow rate of the produced hydrogen is equal to or greater than the required hydrogen flow rate. In this state, the hydrogen generation device 11 generates a larger amount of hydrogen than is required by the hydrogen utilization equipment 18. For this reason, the pressure of the hydrogen flowing through the second line 14 may become 0.95 MPa·G or more. When the pressure applied to the relief valve 26 is less than 0.95 MPa·G, the relief valve 26 is closed. On the other hand, when the pressure applied to the relief valve 26 is 0.95 MPa·G or more, the relief valve 26 is in an open state.

When S28 and S29 are executed for the first time after the hydrogen production system 10 is started, it is determined in S3 that the stored hydrogen pressure is lower than 0.3 MPa·G (S3: Y). Therefore, when S28 and S29 are executed first after the hydrogen production system 10 is activated, and the relief valve 26 is opened, hydrogen flows from the second line 14 into the hydrogen storage unit 15, and hydrogen is stored in the hydrogen storage unit 15.

When S28 and S29 are executed for the second or subsequent time after the hydrogen production system 10 is started, it is determined in S6, which will be described later, that the stored hydrogen pressure is not equal to or higher than 0.98 MPa·G (S6: N). Therefore, even if S28 and S29 are executed for the second or subsequent time after the hydrogen production system 10 is started and the relief valve 26 is in an open state, hydrogen will flow from the second line 14 into the hydrogen storage unit 15 and be stored in the hydrogen storage unit 15.

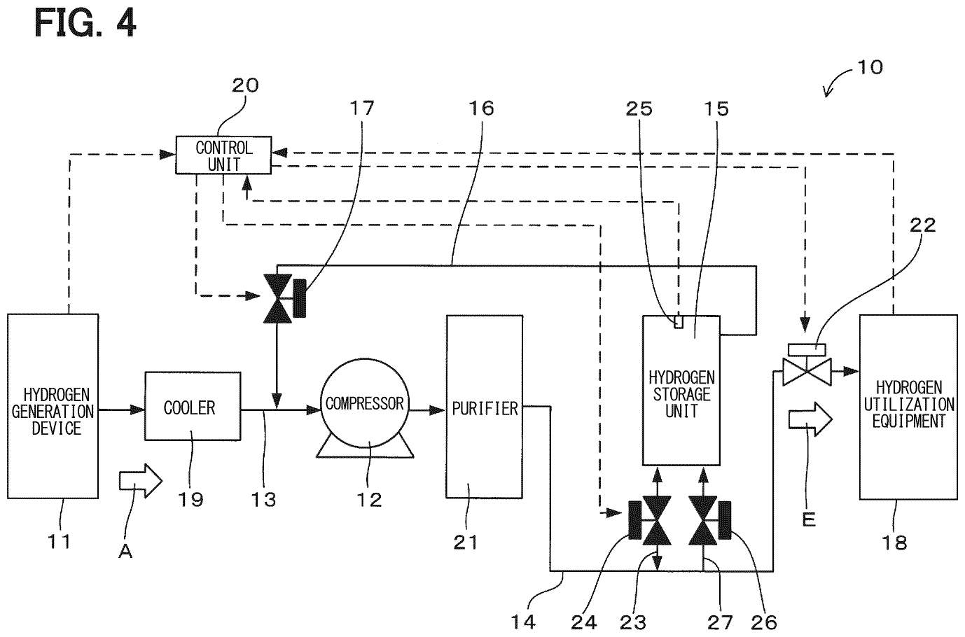

FIG. 4 shows the relief valve 26 in a closed state. In FIG. 4, the supply control valve 22 is shown in white. That is, the supply control valve 22 is in an open state. On the other hand, the first control valve 17, the supply valve 24 and the relief valve 26 shown in black means that the first control valve 17, the supply valve 24 and the relief valve 26 are in a closed state. In this state, the hydrogen generated in the hydrogen generation device 11 flows through the hydrogen generation device 11, the cooler 19, the compressor 12, the purifier 21, the supply control valve 22, and the hydrogen utilization equipment 18, as shown by the arrow A. Hydrogen is supplied to the hydrogen utilization equipment 18 from the hydrogen generation device 11 indicated by the arrow A.

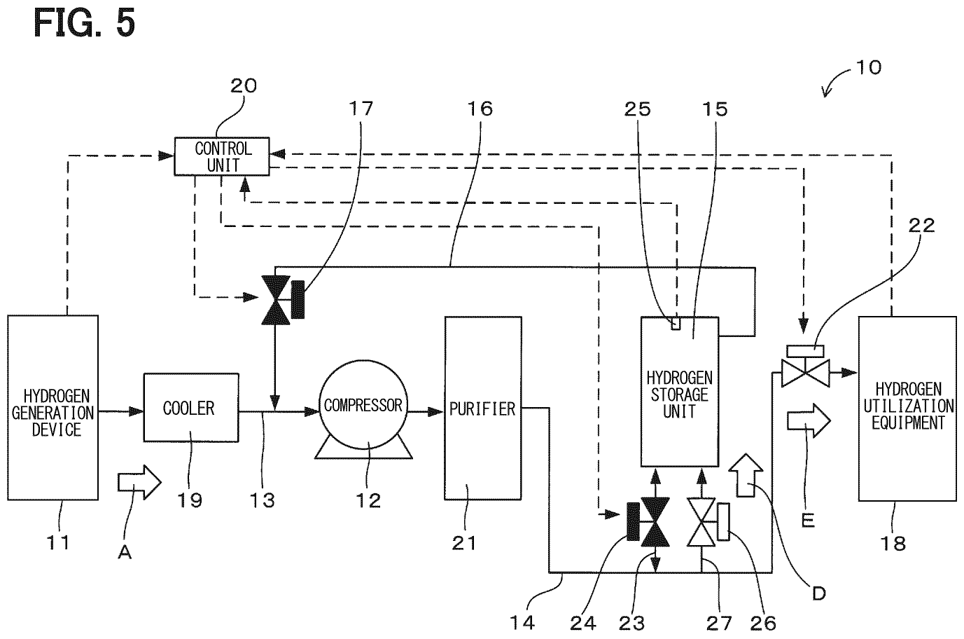

FIG. 5 shows a case where the relief valve 26 is in an open state. In FIG. 5, the relief valve 26 and the supply control valve 22 are shown in white. That is, the relief valve 26 and the supply control valve 22 are in an open state. On the other hand, the first control valve 17 and the supply valve 24 shown in black means that the first control valve 17 and the supply valve 24 are in a closed state. In this state, the hydrogen generated in the hydrogen generation device 11 flows through the hydrogen generation device 11, the cooler 19, the compressor 12, the purifier 21, the supply control valve 22, and the hydrogen utilization equipment 18, as shown by the arrow A, and also passes through the relief valve 26, as shown by the arrow D, to be stored in the hydrogen storage unit 15. The hydrogen utilization equipment 18 is supplied with hydrogen from the hydrogen generation device 11 indicated by the arrow A minus the amount of hydrogen stored in the hydrogen storage unit 15 indicated by the arrow D.

As shown in FIG. 9, when S24, S27 or S29 is completed, the control unit 20 acquires hydrogen pressure and flow rate signals (S25). That is, the control unit 20 receives a signal of the produced hydrogen flow rate from the hydrogen generation device 11, signals of the required hydrogen pressure and the required hydrogen flow rate from the hydrogen utilization equipment 18, and a signal of the stored hydrogen pressure from the hydrogen storage unit 15. The ON process ends at S25, and the process proceeds to the next step.

Returning to FIG. 8, the control unit 20 determines whether the stored hydrogen pressure is equal to or greater than 0.98 MPa·G (S6).

When the control unit 20 determines that the stored hydrogen pressure is 0.98 MPa·G or more (S6: Y), the control unit 20 stops the hydrogen generation device 11 (S11). Next, the control unit 20 executes an OFF process (S9) which will be described later.

The control unit 20 repeats the processes of S5 to S7 until receiving an end command to stop the hydrogen production system 10 (S7), when the produced hydrogen flow rate is not greater than the required hydrogen flow rate or the stored hydrogen pressure is less than 0.95 MPa·G (S6: N). When the control unit 20 receives the end command (S7: Y), the control unit 20 executes a finalization process (S8). That is, the control unit 20 stops the hydrogen generation device 11, the cooler 19, the compressor 12, and the purifier 21. In addition, the control unit 20 closes the first control valve 17, the supply valve 24, and the supply control valve 22. With the above, the operation of the hydrogen production system 10 ends.

An OFF process will be described. In S3 of FIG. 8, when the control unit 20 determines that the stored hydrogen pressure is not lower than 0.3 MPa·G (S3: N), the control unit 20 causes the hydrogen production system 10 to execute the OFF process. The OFF process is executed when the hydrogen generation device 11 is stopped.

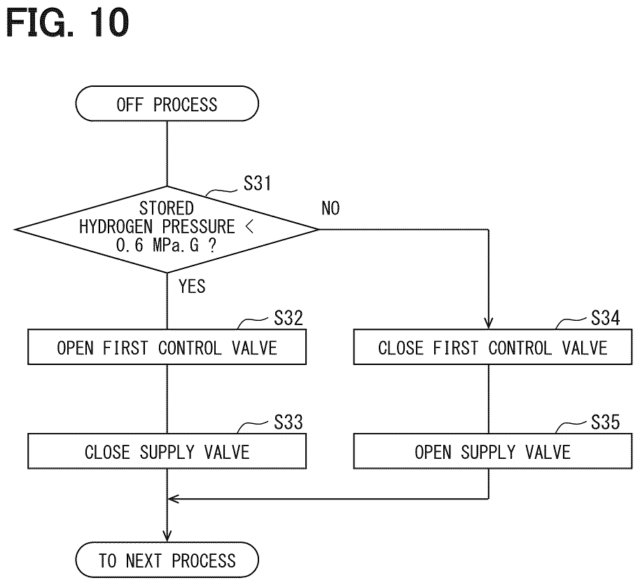

FIG. 10 shows a flowchart of the OFF process. The control unit 20 determines whether the stored hydrogen pressure is less than 0.6 MPa·G (S31). When the control unit 20 determines that the stored hydrogen pressure is lower than 0.6 MPa·G (S31: Y), the control unit 20 opens the first control valve 17 (S32). Furthermore, the control unit 20 closes the supply valve 24 (S33).

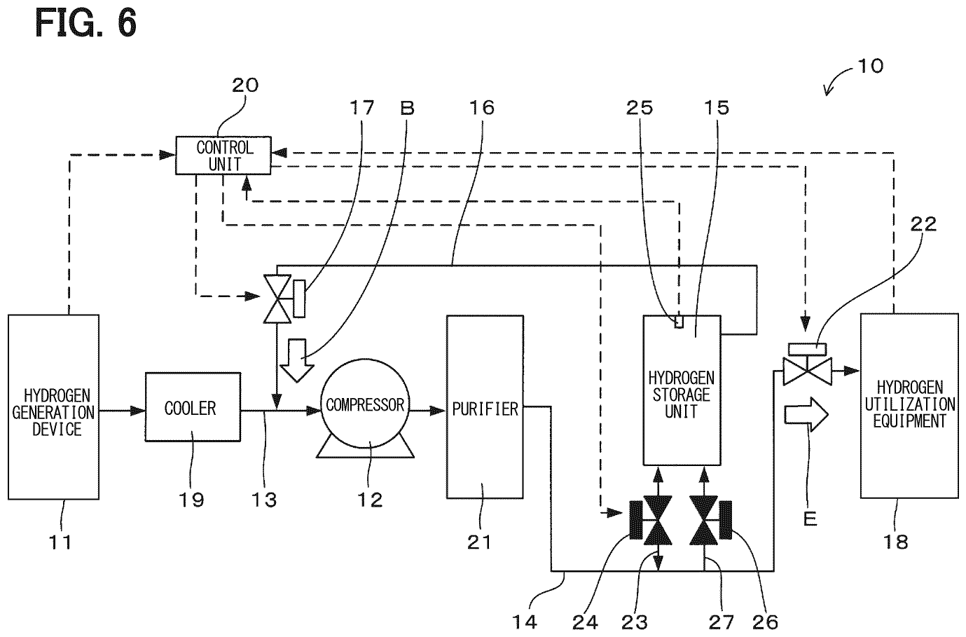

In FIG. 6, the first control valve 17 and the supply control valve 22 are shown in white. In other words, the first control valve 17 and the supply control valve 22 are in an open state. On the other hand, the supply valve 24 and the relief valve 26 shown in black means that the supply valve 24 and the relief valve 26 are in a closed state. In this state, the hydrogen stored in the hydrogen storage unit 15 passes through the hydrogen storage unit 15, the first bypass line 16 and the first control valve 17, as shown by the arrow B, and flows into the first line 13 to flow through the compressor 12, the purifier 21, the supply control valve 22 and the hydrogen utilization equipment 18. The hydrogen supplied to the hydrogen utilization equipment 18 is indicated by the arrow E. Hydrogen is supplied to the hydrogen utilization equipment 18 from the hydrogen storage unit 15 indicated by the arrow B.

As shown in FIG. 10, when the control unit 20 determines that the stored hydrogen pressure is not lower than 0.6 MPa·G (S31: N), the control unit 20 closes the first control valve 17 (S34). Furthermore, the control unit 20 opens the supply valve 24 (S35).

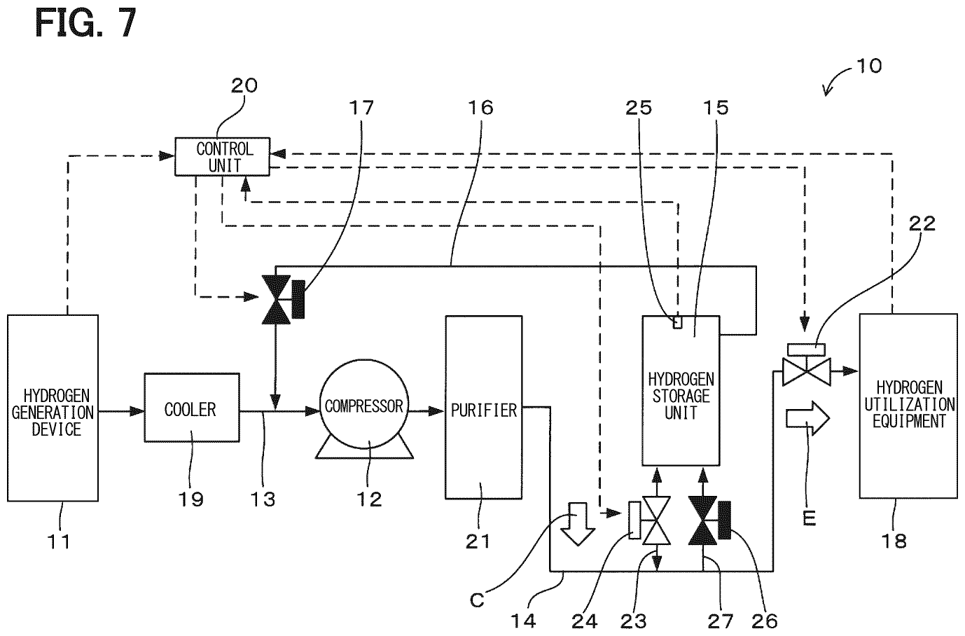

In FIG. 7, the supply valve 24 and the supply control valve 22 are shown in white. That is, the supply valve 24 and the supply control valve 22 are in an open state. On the other hand, the first control valve 17 and the relief valve 26 shown in black means that the first control valve 17 and the relief valve 26 are in a closed state. In this state, the hydrogen stored in the hydrogen storage unit 15 passes through the supply valve 24, as shown by the arrow C, joins the second line 14, and flows to the supply control valve 22 and the hydrogen utilization equipment 18. Hydrogen is supplied to the hydrogen utilization equipment 18 from the hydrogen storage unit 15 indicated by the arrow C.

Returning to FIG. 10, when S33 or S35 ends, the OFF process ends and the process moves to the next step.

Returning to FIG. 8, when the control unit 20 finishes the OFF process (S9), the control unit 20 repeats the processes from S2 onwards until receiving an end command to stop the hydrogen production system 10 (S10: N). When the control unit 20 receives the end command (S10: Y), the control unit 20 executes the finalization process (S8). This ends the operation of the hydrogen production system 10.

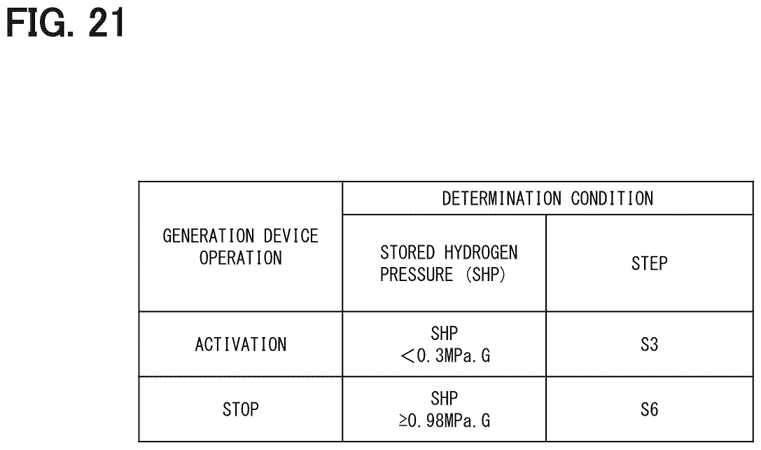

The operations of the hydrogen generation device 11 and the valves will be described. FIG. 21 summarizes the conditions for determining whether the control unit 20 should activate the hydrogen generation device 11 in a stopped state, and the conditions for determining whether the control unit 20 should stop the hydrogen generation device 11 in an operating state.

As shown in FIG. 21, when the hydrogen generation device 11 is in a stopped state, if the stored hydrogen pressure is less than 0.3 MPa·G (S3: Y), the hydrogen generation device 11 is started (S4). The value of 0.3 MPa·G takes into consideration the response delay from when the hydrogen generation device 11 is started until the stored hydrogen pressure in the hydrogen storage unit 15 reaches 0 MPa·G before hydrogen is supplied to the hydrogen utilization equipment 18. The value of the stored hydrogen pressure determined in S3 is not particularly limited, and any value may be adopted depending on the hydrogen production system 10.

When the hydrogen generation device 11 is in operation and the stored hydrogen pressure is 0.98 MPa·G or higher (S6: Y), the hydrogen generation device 11 is stopped (S11). The value of 0.98 MPa·G is set based on the upper limit pressure set in the hydrogen storage unit 15 of this embodiment. The upper limit pressure of the hydrogen storage unit 15 and the value based on this upper limit pressure are not particularly limited, and are set individually depending on the hydrogen production system 10.

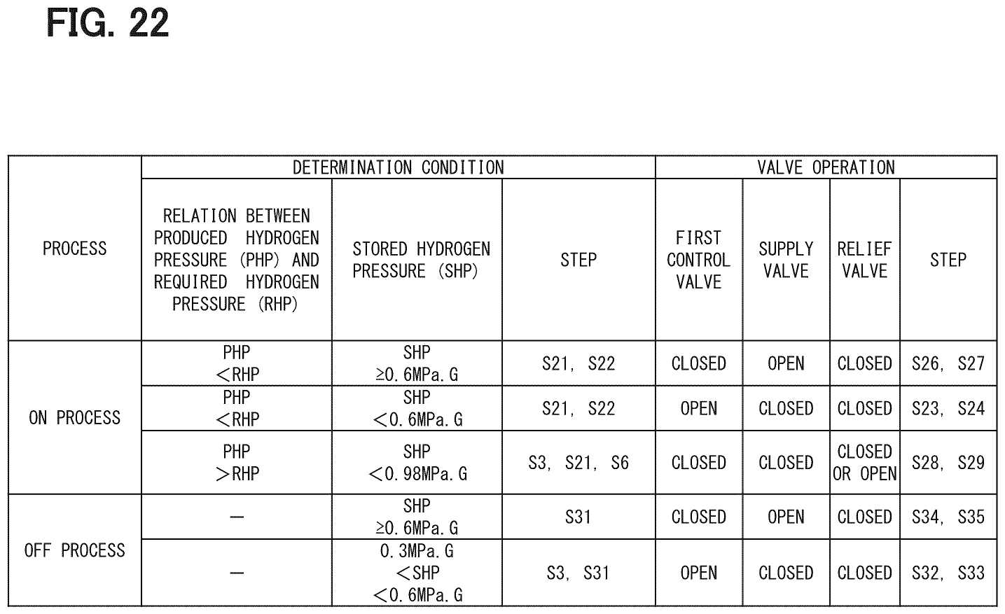

Next, FIG. 22 summarizes the conditions for opening/closing the first control valve 17 and the supply valve 24 by the control unit 20.

As shown in FIG. 22, when the ON process is being executed, if the produced hydrogen flow rate is smaller than the required hydrogen flow rate (S21: Y) and if the stored hydrogen pressure is not smaller than 0.6 MPa·G (S22: N), the control unit 20 closes the first control valve 17 (S26) and opens the supply valve 24 (S27).

Furthermore, when the ON process is being executed, if the produced hydrogen flow rate is smaller than the required hydrogen flow rate (S21: Y) and if the stored hydrogen pressure is smaller than 0.6 MPa·G (S22: Y), the control unit 20 opens the first control valve 17 (S23) and closes the supply valve 24 (S24).

Furthermore, when the ON process is being executed, if the produced hydrogen flow rate is not smaller than the required hydrogen flow rate (S21: N), the control unit 20 closes the first control valve 17 (S28) and closes the supply valve 24 (S29). When a pressure of 0.95 MPa·G or more is not applied to the relief valve 26, the relief valve 26 is in a closed state. When a pressure of 0.95 MPa·G or more is applied to the relief valve 26, the relief valve 26 is in an open state.

Furthermore, as shown in FIG. 22, when the OFF process is being executed, if the stored hydrogen pressure is not less than 0.6 MPa·G (S31: N), the control unit 20 closes the first control valve 17 (S34) and opens the supply valve 24 (S35).

Furthermore, when the OFF process is being executed, if the stored hydrogen pressure is lower than 0.6 MPa·G (S31: Y), the control unit 20 opens the first control valve 17 (S32) and closes the supply valve 24 (S33). Since no predetermined pressure is applied to the relief valve 26, the relief valve 26 is in a closed state.

Next, the effects of this embodiment will be described below. According to this embodiment, by opening the first control valve 17, hydrogen stored in the hydrogen storage unit 15 can be circulated to the first line 13 via the first bypass line 16. The hydrogen circulated through the first line 13 is compressed by the compressor 12 and then circulated through the second line 14 and supplied to the hydrogen utilization equipment 18. This makes it possible to use up the hydrogen stored in the hydrogen storage unit 15 even when it is difficult to supply hydrogen from the hydrogen storage unit 15 to the second line 14, for example, since the pressure of the hydrogen stored in the hydrogen storage unit 15 falls below the pressure of the hydrogen circulating through the second line 14.

The hydrogen production system 10 according to this embodiment further includes the storage pressure sensor 25 that detects the pressure of hydrogen stored in the hydrogen storage unit 15, and the control unit 20 that controls the first control valve 17. The control unit 20 receives a signal of the stored hydrogen pressure from the storage pressure sensor 25, a signal of the flow rate of hydrogen generated by the hydrogen generation device 11, and a signal of the required hydrogen flow rate required by the hydrogen utilization equipment 18. The control unit 20 opens the first control valve 17 at least when the produced hydrogen flow rate is smaller than the required hydrogen flow rate, provided that the stored hydrogen pressure is smaller than a threshold value set based on the required hydrogen pressure.

For example, when the production conditions of the hydrogen generation device 11 are changed or the opening degree of the first control valve 17 is changed, the flow rate and pressure of the hydrogen circulating within the hydrogen production system 10 change. At this time, when the production conditions of the hydrogen generation device 11 are changed or when the opening degree of the first control valve 17 is changed, it is conceivable that a response delay will occur before the hydrogen produced under the changed condition is supplied to the hydrogen utilization equipment 18. For this reason, a threshold value that takes into account the above-mentioned response delay is set for the required hydrogen pressure, and the production conditions of the hydrogen production system 10 are changed based on this threshold value. This threshold value varies depending on the response delay of the hydrogen production system 10 and the hydrogen pressure required by the hydrogen utilization equipment 18, and is therefore set individually for each hydrogen production system 10.

According to this embodiment, even if the stored hydrogen pressure is lower than the threshold value based on the required hydrogen pressure, the hydrogen stored in the hydrogen storage unit 15 can be circulated in the order of the first bypass line 16, the first control valve 17, the first line 13, the compressor 12 and the second line 14, and supplied to the hydrogen utilization equipment 18. This makes it possible to easily use up the hydrogen stored in the hydrogen storage unit 15. The threshold value is set arbitrarily based on the hydrogen pressure required by the hydrogen utilization equipment 18.

In this embodiment, the hydrogen storage unit 15 and the second line 14 are connected by the supply line 23. The supply line 23 is provided with at least one valve that controls the flow of hydrogen between the hydrogen storage unit 15 and the second line 14. In this embodiment, the supply valve 24 and the relief valve 26 are provided between the hydrogen storage unit 15 and the second line 14. The valves make it possible to control the flow of hydrogen between the second line 14 and the hydrogen storage unit 15.

The relief valve 26 is configured to allow hydrogen to flow from the second line 14 to the hydrogen storage unit 15 and to prohibit hydrogen from flowing from the hydrogen storage unit 15 to the second line 14 when the pressure in the second line 14 exceeds a predetermined pressure.

When the amount of hydrogen generated by the hydrogen generation device 11 is greater than the amount of hydrogen required by the hydrogen utilization equipment 18, hydrogen can be supplied to the hydrogen utilization equipment 18 while the excess hydrogen for the hydrogen utilization equipment 18 can be stored in the hydrogen storage unit 15.

As described above, according to the hydrogen production system 10 of the present embodiment, it is possible to use up the hydrogen stored in the hydrogen storage unit 15.

### Second Embodiment

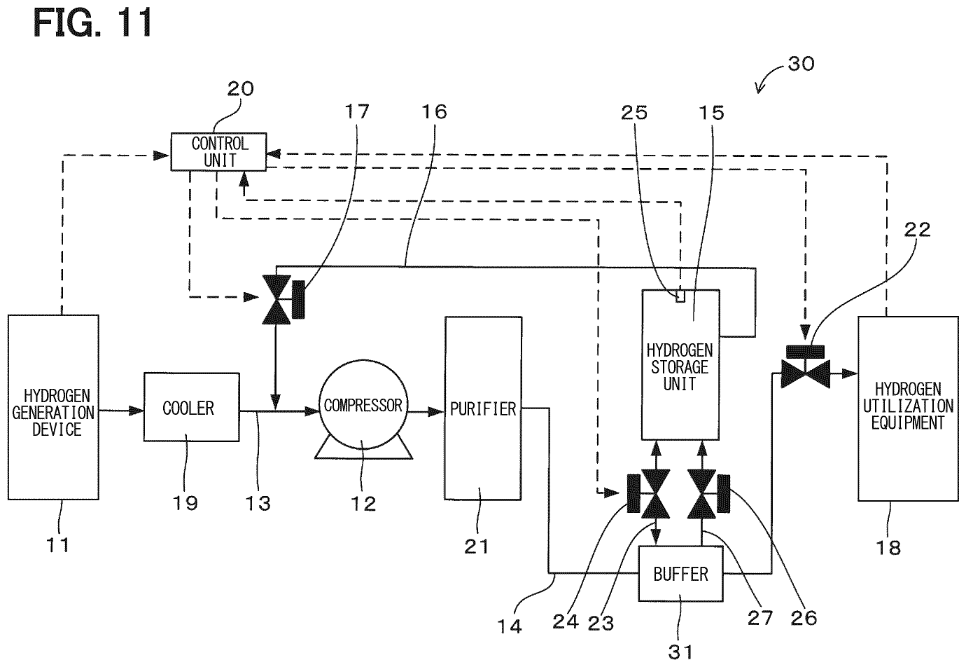

Next, a hydrogen production system 30 according to a second embodiment will be described with reference to FIG. 11. In the present embodiment, a buffer 31 having an inner diameter larger than that of the other part of the second line 14 is provided in the second line 14 adjacent to the supply valve 24 and the relief valve 26. The buffer 31 may be a tank having a smaller capacity than the hydrogen storage unit 15, or a pipe having an inner diameter larger than that of the pipe of the second line 14, and may be selected appropriately as required.

The reference numerals used in the second and subsequent embodiments which are the same reference numerals as those used in the previous embodiment denote the same components as in the previous embodiment unless otherwise indicated.

In the hydrogen production system 30, when a process is executed on a specific device of the hydrogen production system 30, a time delay occurs before the effect of this process reaches the other device. For example, when the hydrogen generation device 11 generates excessive hydrogen and is stopped, it takes time for the pressure of the hydrogen circulating through the first line 13 and the second line 14 to decrease, and further for the pressure of the hydrogen supplied to the hydrogen utilization equipment 18 to decrease. Similarly, when various valves in the hydrogen production system 30 are opened or closed, there is a time delay before the pressure in the first line 13 or the second line 14, in which the valve is provided, changes to the desired pressure.

In this embodiment, the buffer 31 is provided in the second line 14. As a result, when processing is performed in the hydrogen production system 30, the response delay of the pressure fluctuation of the hydrogen flowing through the second line 14 can be alleviated by the buffer 31. In particular, the supply valve 24 and the relief valve 26 are provided between the second line 14 and the hydrogen storage unit 15, and this makes it possible to effectively reduce the response delay of pressure fluctuation when the valves are opened/closed. Furthermore, when the first control valve 17 connecting the hydrogen storage unit 15 and the first line 13 is opened or closed, the stored hydrogen pressure of the hydrogen stored in the hydrogen storage unit 15 also fluctuates significantly. This response delay of the stored hydrogen pressure can also be alleviated by the buffer 31, which is particularly effective.

The buffer 31 can be constituted by a tank capable of storing hydrogen, or a pipe having an inner diameter larger than that of the second line 14. The buffer 31 can be formed with such a simple structure.

### Third Embodiment

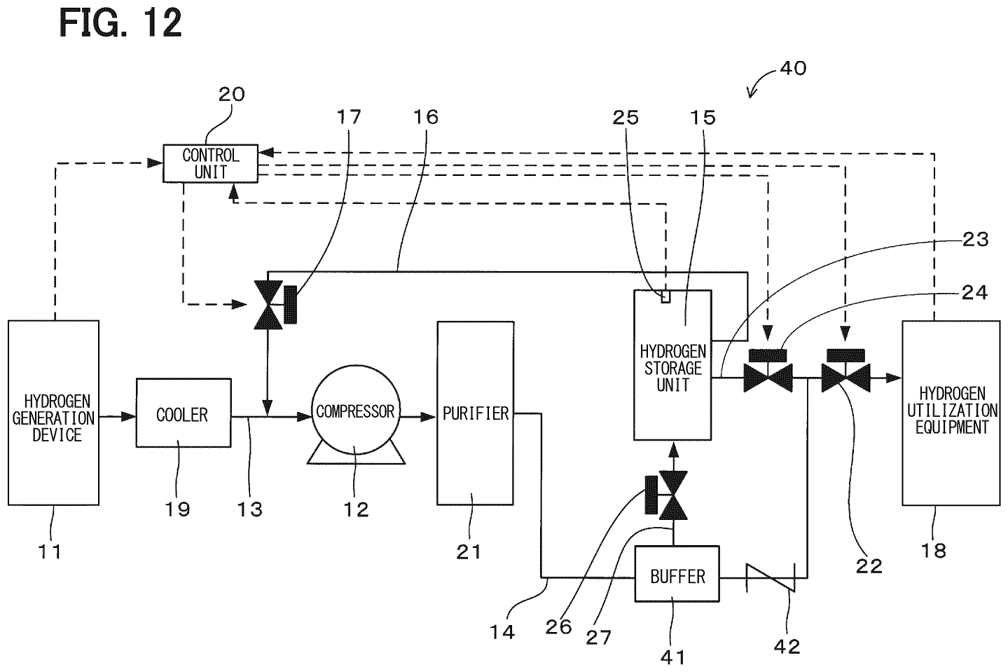

Next, a hydrogen production system 40 according to a third embodiment will be described with reference to FIG. 12. This embodiment is a modification of the second embodiment. In this embodiment, the supply line 23 is connected between the buffer 41 and the supply control valve 22. As a result, in this embodiment, no buffer is interposed between the supply valve 24 and the hydrogen utilization equipment 18. As a result, it is possible to reduce the response delay in the hydrogen utilization equipment 18 when the supply valve 24 is opened or closed. In addition, a check valve 42 is disposed between the buffer 41 and a connection portion between the supply line 23 and the second line 14. This allows hydrogen to flow from the buffer 41 to the hydrogen utilization equipment 18, while restricting hydrogen from flowing back from the hydrogen storage unit 15 to the buffer 41.

### Fourth Embodiment

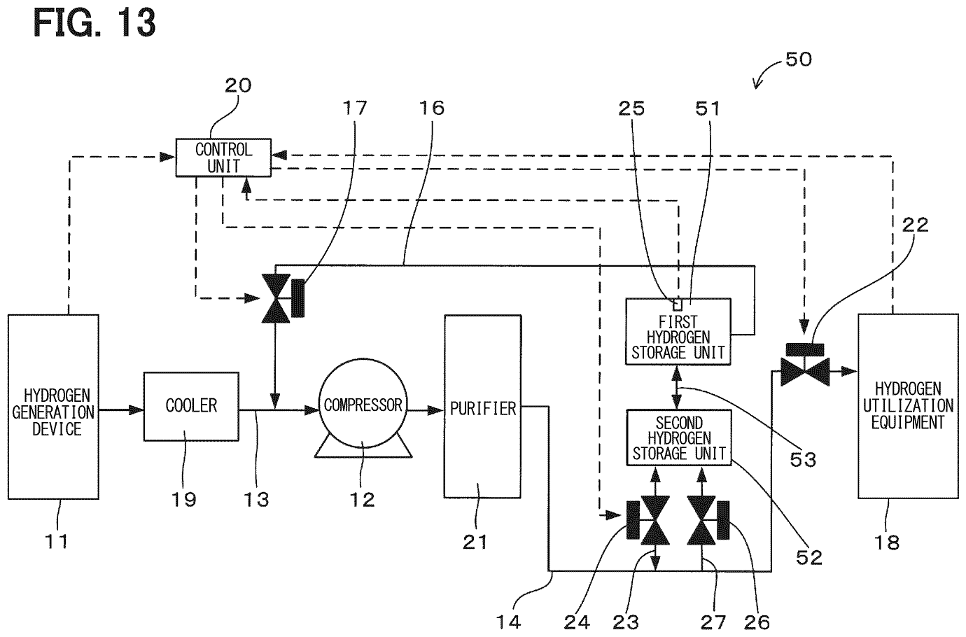

Next, a hydrogen production system 50 according to a fourth embodiment will be described with reference to FIG. 13. In this embodiment, the first bypass line 16 is connected to a first hydrogen storage unit 51 capable of storing hydrogen therein. The first hydrogen storage unit 51 is connected by a connecting line 53 to a second hydrogen storage unit 52 capable of storing hydrogen therein. The hydrogen stored in the first hydrogen storage unit 51 and the hydrogen stored in the second hydrogen storage unit 52 can flow between each other via the connecting line 53. The connecting line 53 includes a pipe. The connecting line 53 may be provided with a valve.

The second hydrogen storage unit 52 is connected to the second line 14 by the supply line 23 and the relief line 27.

The volume of the first hydrogen storage unit 51 and the volume of the second hydrogen storage unit 52 may be the same or different. In this embodiment, the volume of the first hydrogen storage unit 51 is larger than the volume of the second hydrogen storage unit 52. The volume of the first hydrogen storage unit 51 may be smaller than the volume of the second hydrogen storage unit 52.

The storage pressure sensor 25 is disposed in the first hydrogen storage unit 51. However, the storage pressure sensor 25 may be disposed in both the first hydrogen storage unit 51 and the second hydrogen storage unit 62, or may be disposed in the second hydrogen storage unit 52.

Although the hydrogen production system 50 according to the present embodiment includes the first hydrogen storage unit 51 and the second hydrogen storage unit 52, the hydrogen production system 50 of the present embodiment is not limited to this and may include three or more hydrogen storage units.

According to this embodiment, hydrogen can be divided and stored in the first hydrogen storage unit 51 and the second hydrogen storage unit 52. This allows the manufacturing costs of the hydrogen production system 50 to be reduced compared to when hydrogen is stored in one large hydrogen storage unit.

### Fifth Embodiment

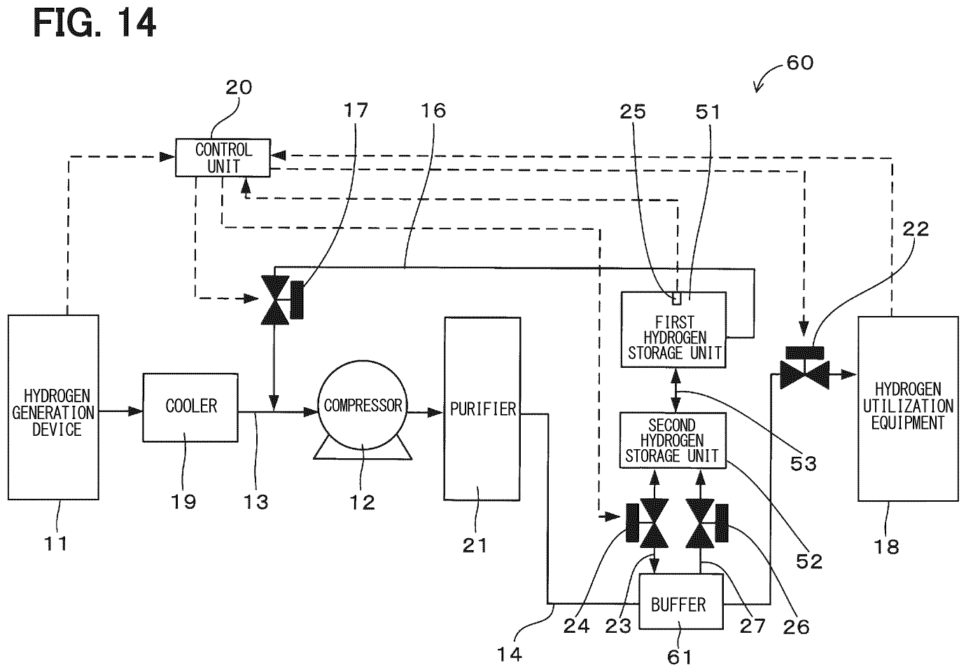

Next, a hydrogen production system 60 according to a fifth embodiment will be described with reference to FIG. 14. This embodiment differs from the fourth embodiment in that a buffer 61 having an inner diameter larger than that of other portion of the second line 14 is provided in the second line 14 adjacent to the supply valve 24 and the relief valve 26.

According to this embodiment, when the first control valve 17 or the supply valve 24 is opened or closed, the response delay caused by the first hydrogen storage unit 51 and the second hydrogen storage unit 52 can be effectively alleviated by the buffer 61.

### Sixth Embodiment

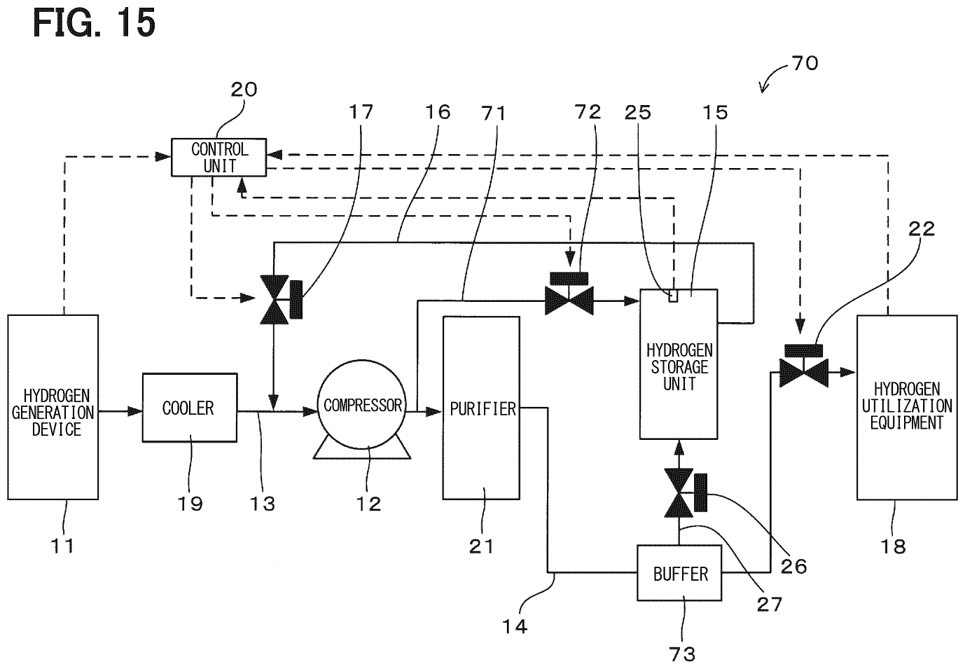

Next, a hydrogen production system 70 according to a sixth embodiment will be described with reference to FIGS. 15 to 20. As shown in FIG. 15, in this embodiment, a second bypass line 71 is provided to connect a part of the second line 14 between the compressor 12 and the purifier 21 to the hydrogen storage unit 15. Due to the second bypass line 71, the hydrogen circulating through the second line 14 is supplied to the hydrogen storage unit 15 from the region between the compressor 12 and the purifier 21.

The second bypass line 71 has a second control valve 72. By adjusting the opening degree of the second control valve 72, the amount of hydrogen flowing through the second bypass line 71 can be controlled. The control unit 20 is configured to control the opening degree of the second control valve 72 based on the produced hydrogen flow rate, the required hydrogen pressure, the required hydrogen flow rate, and the stored hydrogen pressure. The second control valve 72 may be, for example, a solenoid valve.

The second line 14 has a buffer 73. The inner diameter of the buffer 73 is set to be larger than the inner diameter of the other portion of the second line 14 that is different from the buffer 73. The buffer 73 and the hydrogen storage unit 15 are connected by a relief line 27. The relief line 27 is provided with a relief valve 26.

In the hydrogen production system 70 according to this embodiment, the supply line 23 and the supply valve 24 are not provided between the hydrogen storage unit 15 and the buffer 73.

In FIG. 15, the first control valve 17, the second control valve 72, the relief valve 26 and the supply control valve 22 are shown in black, that is, in a closed state.

The other configuration is substantially the same as in the first embodiment, so the same components are given the same reference numerals and duplicated explanations are omitted.

Next, a hydrogen production process of the hydrogen production system 70 will be described. The hydrogen production process is not limited to the following description.

When the hydrogen production system 70 is stopped, the first control valve 17, the second control valve 72, and the supply control valve 22 provided in the hydrogen production system 70 are in a closed state as shown in FIG. 15. When the hydrogen production system 70 is stopped, no pressure is applied to the relief valve 26, so the relief valve 26 is in a closed state.

In the hydrogen production process of the hydrogen production system 70 of this embodiment, the contents of the ON process and the OFF process are different from those of the first embodiment. The main routine of the hydrogen production process is the same as that of the first embodiment, so a duplicated explanation will be omitted.

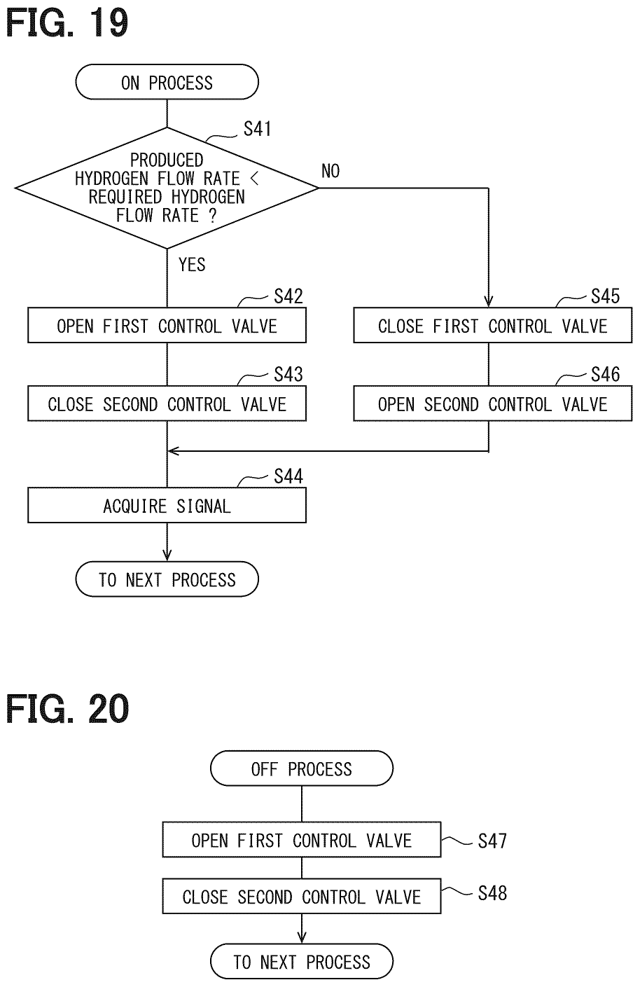

FIG. 19 shows a flowchart of the ON process. The control unit 20 determines whether the produced hydrogen flow rate is smaller than the required hydrogen flow rate (S41). When the control unit 20 determines that the produced hydrogen flow rate is smaller than the required hydrogen flow rate (S41: Y), the control unit 20 opens the first control valve 17 (S42). Furthermore, the control unit 20 closes the second control valve 72 (S43).

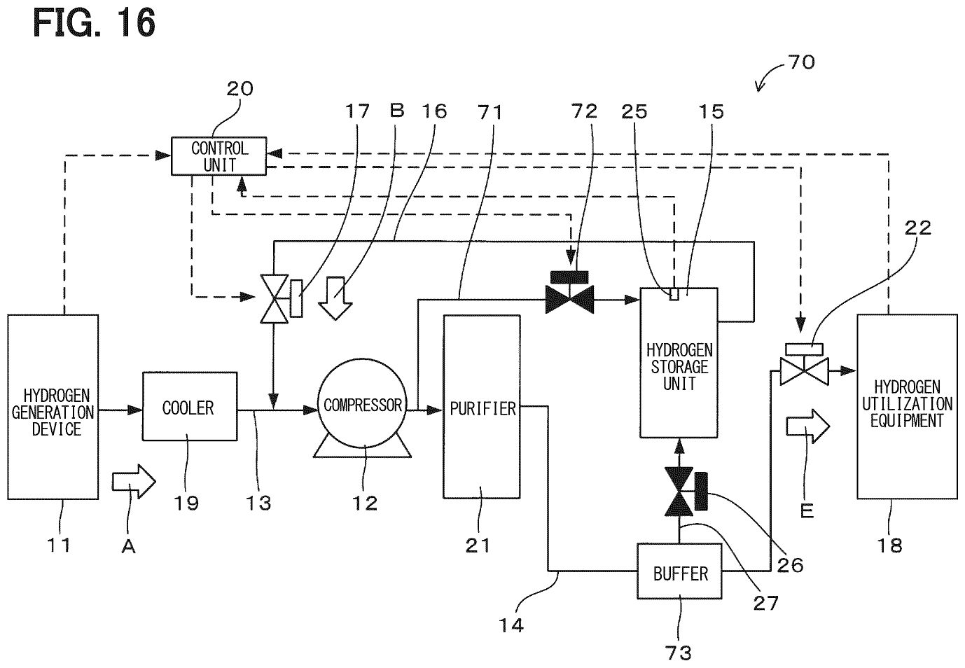

In FIG. 16, the first control valve 17 and the supply control valve 22 are shown in white. In other words, the first control valve 17 and the supply control valve 22 are in an open state. On the other hand, the second control valve 72 and the relief valve 26 are shown in black, that is, the second control valve 72 and the relief valve 26 are in a closed state. In this state, the hydrogen generated in the hydrogen generation device 11 flows through the hydrogen generation device 11, the cooler 19, the compressor 12, the purifier 21, the buffer 73, the supply control valve 22, and the hydrogen utilization equipment 18, as shown by the arrow A. In addition, the hydrogen stored in the hydrogen storage unit 15 passes through the hydrogen storage unit 15, the first bypass line 16, and the first control valve 17, as shown by the arrow B, and flows to the first line 13, the compressor 12, the purifier 21, the buffer 73, the supply control valve 22, and the hydrogen utilization equipment 18. The hydrogen supplied to the hydrogen utilization equipment 18 is indicated by the arrow E. Hydrogen from the hydrogen generation device 11 indicated by the arrow A and hydrogen from the hydrogen storage unit 15 indicated by the arrow B are supplied to the hydrogen utilization equipment 18 in a joined state.

As shown in FIG. 19, when the control unit 20 determines in S41 that the produced hydrogen pressure is not lower than the required hydrogen pressure (S41: N), the control unit 20 closes the first control valve 17 (S45). Furthermore, the control unit 20 opens the second control valve 72 (S46).

When S45 and S46 are executed by the control unit 20, the produced hydrogen flow rate is not smaller than the required hydrogen flow rate (S41: N). In other words, the flow rate of the produced hydrogen is equal to or greater than the required hydrogen flow rate. In this state, the hydrogen generation device 11 generates a larger amount of hydrogen than is required by the hydrogen utilization equipment 18. For this reason, the pressure of the hydrogen flowing through the second line 14 may become 0.95 MPa·G or more. When the pressure applied to the relief valve 26 is less than 0.95 MPa·G, the relief valve 26 is closed. On the other hand, when the pressure applied to the relief valve 26 is 0.95 MPa·G or more, the relief valve 26 is in an open state.

When the hydrogen production system 70 is started and S45 and S46 are executed for the first time, it is determined in S3 that the stored hydrogen pressure is lower than 0.3 MPa·G (FIG. 8, S3: Y). Therefore, when the hydrogen production system 70 is started and S45 and S46 are executed first, and the relief valve 26 is opened, hydrogen flows from the buffer 73 into the hydrogen storage unit 15 and is stored in the hydrogen storage unit 15.

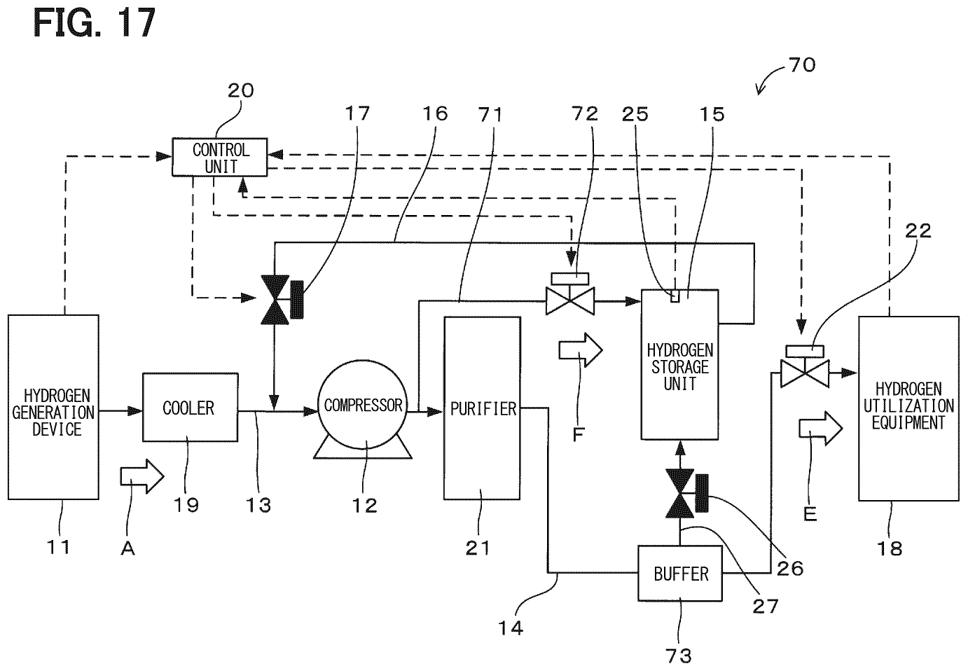

In FIG. 17, the second control valve 72 and the supply control valve 22 are shown in white. In other words, the second control valve 72 and the supply control valve 22 are in an open state. On the other hand, the first control valve 17 and the relief valve 26 are shown in black, that is, the first control valve 17 and the relief valve 26 are in a closed state. In this state, the hydrogen generated in the hydrogen generation device 11 flows through the hydrogen generation device 11, the cooler 19, the compressor 12, the purifier 21, the buffer 83, the supply control valve 22, and the hydrogen utilization equipment 18, as shown by the arrow A. The hydrogen travels from the second line 14 through the second control valve 72 and is stored in the hydrogen storage unit 15. The hydrogen utilization equipment 18 is supplied with hydrogen generated by the hydrogen generation device 11 indicated by the arrow A minus hydrogen stored in the hydrogen storage unit 15 indicated by the arrow F.

As shown in FIG. 19, when S43 or S46 is completed, the control unit 20 acquires various hydrogen pressure and flow rate signals (S44). That is, the control unit 20 receives a signal of the produced hydrogen flow rate from the hydrogen generation device 11, signals of the required hydrogen pressure and the required hydrogen flow rate from the hydrogen utilization equipment 18, and a signal of the stored hydrogen pressure from the hydrogen storage unit 15. The ON process ends at S44, and the process proceeds to the next step. The control unit 20 executes the processes from S6 onward in FIG. 8.

FIG. 20 shows a flowchart of the OFF process. The control unit 20 opens the first control valve 17 (S47). Furthermore, the control unit 20 closes the second control valve 72 (S48).

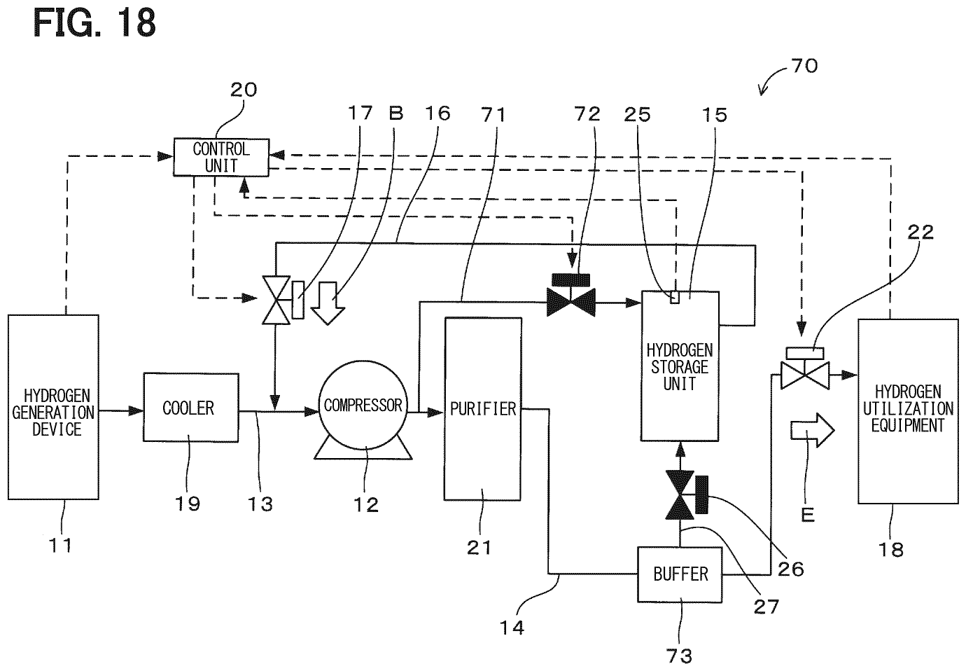

In FIG. 18, the first control valve 17 and the supply control valve 22 are shown in white. In other words, the first control valve 17 and the supply control valve 22 are in an open state. On the other hand, the second control valve 72 and the relief valve 26 are shown in black, that is, the second control valve 72 and the relief valve 26 are in a closed state. In this state, the hydrogen stored in the hydrogen storage unit 15 passes through the hydrogen storage unit 15, the first bypass line 16 and the first control valve 17, as shown by the arrow B, to join the first line 13, and then flows to the compressor 12, the purifier 21, the buffer 83, the supply control valve 22 and the hydrogen utilization equipment 18. The hydrogen supplied to the hydrogen utilization equipment 18 is indicated by the arrow E. Hydrogen is supplied to the hydrogen utilization equipment 18 from the hydrogen storage unit 15 indicated by the arrow B.

As shown in FIG. 20, when S48 is completed, the OFF process is completed and the process moves to the next step. The control unit 20 executes the processes from S10 onward in FIG. 8.

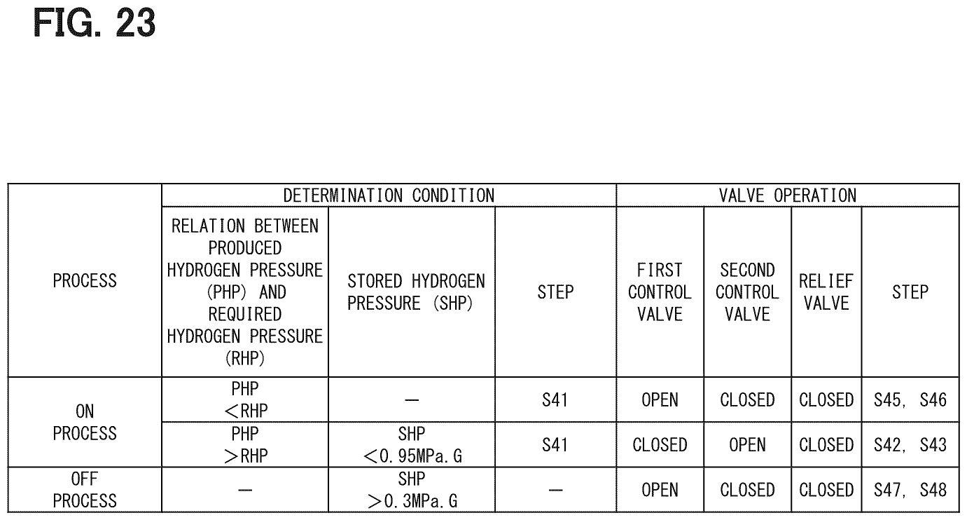

Operations of the hydrogen generation device 11 and the valves will be described. FIG. 23 summarizes the conditions for the control unit 20 to open/close the first control valve 17 and the second control valve 72.

As shown in FIG. 23, when the ON process is being executed, when the produced hydrogen flow rate is smaller than the required hydrogen flow rate (S41: Y), the control unit 20 opens the first control valve 17 (S42) and closes the second control valve 72 (S43).

When the ON process is being executed, when the produced hydrogen flow rate is not smaller than the required hydrogen flow rate (S41: N), the control unit 20 closes the first control valve 17 (S45) and opens the second control valve 72 (S46).

As shown in FIG. 23, when the OFF process is being executed, the first control valve 17 is opened (S47), and the second control valve 72 is closed (S48).

The conditions for determining whether the control unit 20 should activate the hydrogen generation device 11 in a stopped state and the conditions for determining whether the control unit 20 should stop the hydrogen generation device 11 in an operating state are the same as those in the first embodiment, and therefore duplicate explanations will be omitted.

Next, the effects of this embodiment will be described. According to this embodiment, the second line 14 has the purifier 21 between the compressor 12 and the hydrogen storage unit 15 to remove impurities from the hydrogen. A part of the second line 14 between the compressor 12 and the purifier 21 is connected to the hydrogen storage unit 15 by the second bypass line 71. The second bypass line 71 is arranged to bypass the purifier 21. The second bypass line 71 has the second control valve 72 that controls the flow of hydrogen flowing through the second bypass line 71.

By opening the second control valve 72, hydrogen to be stored in the hydrogen storage unit 15 can be circulated to the hydrogen storage unit 15 via the second bypass line 71, and the hydrogen can be stored in the hydrogen storage unit 15 without passing through the purifier 21. This makes it possible to reduce the pressure loss in the purifier 21.

The present disclosure is not limited to the respective embodiments described above, and various modifications may be adopted within the scope of the present disclosure without departing from the spirit of the disclosure.

The hydrogen pressure required by the hydrogen utilization equipment 18 is not particularly limited, and may be greater than 1 MPa·G, for example, 10 MPa·G. The upper limit pressure of the hydrogen storage unit 15 is not particularly limited, and may be, for example, 20 MPa·G. The hydrogen pressure at which the relief valve 26 opens may be, for example, 1.0 MPa·G.

The flow rate of the produced hydrogen may be detected directly by a flow meter, or may be calculated from another physical quantity, such as the current value of the hydrogen production device.

The required hydrogen flow rate may be a direct signal received as a required value from the hydrogen utilization equipment, or may be detected to be equal to the hydrogen flow rate used by the equipment. The hydrogen flow rate used by the equipment may be detected directly by a flow meter, or may be estimated from pressure changes in the second supply line or the buffer.

The magnitude relationship between the amount of produced hydrogen and the amount of required hydrogen may be compared by directly detecting the flow rates, or may be estimated from the pressure change in the second supply line or the buffer. The amount of produced hydrogen and the amount of required hydrogen may be compared based on the hydrogen flow rate calculated from another physical quantity such as the current value or the hydrogen flow rate estimated from the pressure change, and any method can be selected.

Although the present disclosure has been described in accordance with the embodiments, it is understood that the present disclosure is not limited to such embodiments or structures. The present disclosure encompasses various modifications and variations within the scope of equivalents. In addition, while the various elements are shown in various combinations and configurations, which are exemplary, other combinations and configurations, including more, less or only a single element, are also within the spirit and scope of the present disclosure.

What is claimed is:

1. A hydrogen production system comprising:
a hydrogen generation device configured to generate hydrogen;
a compressor configured to compress the hydrogen;
a first line connecting the hydrogen generation device to the compressor;
a second line connecting the compressor to a hydrogen utilization equipment to utilize the hydrogen compressed by the compressor;
a hydrogen storage unit configured to store the hydrogen compressed by the compressor;
a first bypass line connecting the hydrogen storage unit to the first line;
a first control valve provided in the first bypass line to control a flow of the hydrogen in the first bypass line;
a storage pressure sensor configured to detect a stored hydrogen pressure of the hydrogen stored in the hydrogen storage unit; and
a control unit configured to control the first control valve, wherein
the control unit receives a signal of the stored hydrogen pressure detected by the storage pressure sensor, a signal of a flow rate of hydrogen generated by the hydrogen generation device, and signals of a required hydrogen pressure and a required hydrogen flow rate required by the hydrogen utilization equipment, and
in case where the flow rate of hydrogen generated by the hydrogen generation device is smaller than the required hydrogen flow rate, when the stored hydrogen pressure is smaller than a threshold value set based on the required hydrogen pressure, the control unit opens the first control valve such that the hydrogen stored in the hydrogen storage unit, which is determined that the stored hydrogen pressure is smaller than the threshold value, flows through the first line.

2. The hydrogen production system according to claim 1, further comprising:
a purifier disposed in the second line between the compressor and the hydrogen storage unit to remove impurities from the hydrogen;
a second bypass line bypassing the purifier and connecting a part of the second line between the compressor and the purifier to the hydrogen storage unit; and
a second control valve provided in the second bypass line to control a flow of the hydrogen in the second bypass line.

3. The hydrogen production system according to claim 1, wherein the second line has a buffer configured to reduce a pressure fluctuation of the hydrogen flowing through the second line.

4. The hydrogen production system according to claim 3, wherein the buffer is a tank capable of storing the hydrogen, or a pipe having an inner diameter larger than that of the second line.

5. The hydrogen production system according to claim 1, wherein
the hydrogen storage unit and the second line are connected by a supply line, and
the supply line has at least one valve to control a flow of hydrogen between the hydrogen storage unit and the second line.

6. The hydrogen production system according to claim 5, wherein the at least one valve connected to the supply line is a relief valve that allows the hydrogen to flow from the second line to the hydrogen storage unit and prohibits the hydrogen from flowing from the hydrogen storage unit to the second line when a pressure in the second line exceeds a predetermined pressure.

7. A hydrogen production system comprising:
a hydrogen generation device configured to generate hydrogen;
a compressor configured to compress the hydrogen;
a first line connecting the hydrogen generation device to the compressor;
a second line connecting the compressor to a hydrogen utilization equipment to utilize the hydrogen compressed by the compressor;
a hydrogen storage unit configured to store the hydrogen compressed by the compressor;
a first bypass line connecting the hydrogen storage unit to the first line;
a first control valve provided in the first bypass line to control a flow of the hydrogen in the first bypass line;
a storage pressure sensor configured to detect a stored hydrogen pressure of the hydrogen stored in the hydrogen storage unit; and
a processor and a memory configured to
receive a signal of the stored hydrogen pressure detected by the storage pressure sensor, a signal of a flow rate of hydrogen generated by the hydrogen generation device, and signals of a required hydrogen pressure and a required hydrogen flow rate required by the hydrogen utilization equipment, and
open the first control valve, when the stored hydrogen pressure is smaller than a threshold value set based on the required hydrogen pressure, in case where the flow rate of hydrogen generated by the hydrogen generation device is smaller than the required hydrogen flow rate, such that the hydrogen stored in the hydrogen storage unit flows through the first line.
